(19) United States
(12) Patent Application Publication
(10) Pub. No.: US 2026/0256136 A1
(43) Pub. Date: Sep. 3, 2026

(54) STABILIZATION OF ALDEHYDES AND/OR AN ALCOHOLS

(71) Applicant: FMC AGRICULTURAL SOLUTIONS A/S, Harboøre (DK)

(72) Inventor: Anders GABRIELSSON, Harboøre (DK)

(21) Appl. No.: 18/846,734

(22) PCT Filed: Mar. 16, 2023
(86) PCT No.: PCT/EP2023/056725

§ 371 Date: Sep. 13, 2024

(30) Foreign Application Priority Data
Mar. 16, 2022 (EP) 22162412.5

(51) Int. Cl. A01N 25/22; A01N 25/10; A01N 31/02; A01N 35/02; A01N 37/06; A01N 43/40; A01N 59/20; A01N 63/10; A01P 7/04

(52) U.S. Cl. CPC A01N 25/22; A01N 25/10; A01N 31/02; A01N 35/02; A01N 37/06; A01N 43/40; A01N 59/20; A01N 63/10; A01P 7/04

(57) ABSTRACT

The present disclosure relates to a method for protecting an aldehyde and/or an alcohol from oxidation and/or from being converted into an acid comprising contacting said aldehyde and/or alcohol with a protective agent comprising a sulfur containing compound.

### TECHNICAL FIELD

The present disclosure relates to protection of aldehydes and/or alcohols from oxidation and/or from being converted acids, for example during storage or in use as well as compositions comprising such protected aldehydes and/or alcohols and methods for using them.

### BACKGROUND

Aldehydes and/or alcohols are vulnerable to oxidation, eg. from O₂ in the air, to become converted into carboxylic acids, see eg. Morrison, R. T.; Boyd, R. N. (1992), Organic Chemistry (6th ed.). Aldehydes can also be degraded by other mechanisms for example aldol condensation, Tishchenko or Cannizarro reactions. Smith, M. B. March J. (2001), March Advanced Organic Chemistry (5^{th} ed.) In products containing aldehydes and/or alcohols as functional and active ingredients there is a need to protect these functional ingredients form being converted into the corresponding inactive forms.

### SUMMARY

The present disclosure describes methods for protecting aldehydes and/or alcohols against oxidation or degradation into corresponding inactive compounds such as carboxylic acids. Accordingly, in a first aspect described herein is a method for protecting an aldehyde and/or an alcohol from oxidation and/or from being converted into an acid or other degradation product comprising contacting said aldehyde and/or alcohol with a protective agent comprising a sulfur containing compound.

In a further aspect described herein is a composition comprising an aldehyde and/or an alcohol and a protective agent comprising a sulfur containing compound, which protects aldehyde and/or an alcohol from oxidation and/or from being converted into an acid.

In a final aspect described herein is a method of controlling or monitoring a pest comprising distributing the composition described herein in a habitat for the pest and allowing the protected aldehyde and/or alcohol to control the pest.

### INCORPORATION BY REFERENCE

All publications, patents, and patent applications referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

The features and advantages of the methods and compositions described herein is readily apparent to a person skilled in the art by the below detailed description of embodiments and examples.

### Definitions

The term “pheromone” as used herein refers to a chemical factor that triggers a social response in members of the same species. Pheromones are typically chemicals capable of acting like hormones outside the body of the secreting individual, to affect the behavior of the receiving individuals. Pheromones include alarm pheromones, food trail pheromones, sex pheromones, and many others that affect behavior or physiology. Pheromones are used by many organisms, from basic unicellular prokaryotes to complex multicellular eukaryotes. Their use among insects has been particularly well documented. In addition, some vertebrates, plants and ciliates communicate by using pheromones. The ecological functions and evolution of pheromones are a major topic of research in the field of chemical ecology.

The term “accelerated storage test” as used herein refers to a well known protocol for investigating the stability of a particular composition. The protocol is described in for example the memorandum dated 16 Nov. 2012 from The United States Environmental Protection Agency Washington, D.C. 20460 with the subject title “Accelerated Storage Stability and Corrosion Characteristics Study Protocol”. The protocol evaluates product stability at 54° C.±2° C. for 14 days.

The term “Cannizzaro reaction” as used herein is well-known in the art and describes a redox reaction involving transfer of a hydride from one aldehyde to another: one aldehyde is oxidized to form the acid, the other is reduced to form the alcohol.

The term “Tishchenko reaction” as used herein refers is well-known in the art and describes a disproportionation reaction that allows the preparation of esters from two equivalents of an aldehyde.

Methods for Protecting Aldehyders and/or Alcohols

The first aspect described herein is a method for where aldehydes and/or an alcohols are protected from oxidation and/or from being converted to an acid, by means of a protective agent comprising a sulfur containing protective compound.

Aldehydes and/or Corresponding Alcohols

In the following section references made to aldehydes applies mutadis mutandis to the corresponding alcohols.

Aldehydes suitable for being protected is particularly fatty aldehydes. In one embodiment of the disclosure, the fatty aldehyde is in a composition which consists of or comprises a single fatty aldehyde. In another embodiment, such fatty aldehyde composition consists of, contain, or comprise a mixture of a few fatty aldehydes, such as 2 to 5 fatty aldehydes. In yet another embodiment, such fatty aldehyde composition consists of or comprises several fatty aldehydes, such as 6 or more fatty aldehydes.

The fatty aldehyde may be a saturated fatty aldehyde, a desaturated fatty aldehyde. In one embodiment of the disclosure, the fatty aldehyde is in a composition which comprises solely saturated fatty aldehydes. In another embodiment, such atty aldehyde composition comprises solely desaturated fatty aldehydes. In yet another embodiment of the present disclosure, the aldehyde composition comprises both saturated and desaturated fatty aldehyde.

In one embodiment, the fatty aldehyde has a chain length of 8. In another embodiment, the fatty aldehyde has a chain length of 9. In another embodiment, the fatty aldehyde has a chain length of 10. In another embodiment, the fatty aldehyde has a chain length of 11. In another embodiment, the fatty aldehyde has a chain length of 12. In another embodiment, the fatty aldehyde has a chain length of 13. In another embodiment, the fatty aldehyde has a chain length of 14. In another embodiment, the fatty aldehyde has a chain length of 15. In another embodiment, the fatty aldehyde has a chain length of 16. In another embodiment, the fatty aldehyde has a chain length of 17. In another embodiment, the fatty aldehyde has a chain length of 18. In another embodiment, the fatty aldehyde has a chain length of 19. In another embodiment, the fatty aldehyde has a chain length of 20. In another embodiment, the fatty aldehyde has a chain length of 21. In another embodiment, the fatty aldehyde has a chain length of 22.

Fatty aldehydes may be branched or unbranched (i.e. linear or “straight-chain”). In a special embodiment the fatty aldehyde is unbranched.

In a special embodiment of the disclosure, the fatty aldehyde has a chain length of 12 to 16. In a further embodiment of the disclosure, the fatty aldehyde is unbranched and has a chain length of 12 to 16. In an even more special embodiment of the disclosure, the fatty aldehyde is unbranched and has a chain length of 12. In another even more special embodiment, the fatty aldehyde is unbranched and has a chain length of 14. In another even more special embodiment, the fatty aldehyde is unbranched and has a chain length of 16.

In one embodiment of the present disclosure, the fatty aldehyde is a saturated fatty aldehyde.

In one embodiment of the disclosure, the fatty aldehyde is a saturated fatty aldehyde having a carbon chain length of 8, 9, 10, 11, 12, 13, 14, 15, 16, 17, 18, 19, 20, 21, or 22.

In one embodiment of the present disclosure, the fatty aldehyde is a desaturated fatty aldehyde. The double bond of the desaturated fatty aldehyde may have either E or Z configuration, except if the double bond is a terminal double bond. In one embodiment of the disclosure, the fatty aldehyde comprises one or more E configured double bonds. In one embodiment of the disclosure, the fatty aldehyde comprises one or more Z configured double bonds. In yet another embodiment, the fatty aldehyde comprises one or more E configured double bonds and one or more Z configured double bonds.

In some embodiments, the fatty aldehyde is a desaturated fatty aldehyde. The desaturated fatty aldehydes may be:
(Z)-Δ3 desaturated fatty aldehydes having a carbon chain length of 8, 9, 10, 11, 12, 13, 14, 15, 16, 17, 18, 19, 20, 21 or 22;
(E)-Δ3 desaturated fatty aldehydes having a carbon chain length of 8, 9, 10, 11, 12, 13, 14, 15, 16, 17, 18, 19, 20, 21 or 22;
(Z)-Δ5 desaturated fatty aldehydes having a carbon chain length of 8, 9, 10, 11, 12, 13, 14, 15, 16, 17, 18, 19, 20, 21 or 22;
(E)-Δ5 desaturated fatty aldehydes having a carbon chain length of 8, 9, 10, 11, 12, 13, 14, 15, 16, 17, 18, 19, 20, 21 or 22;
(Z)-Δ6 desaturated fatty aldehydes having a carbon chain length of 8, 9, 10, 11, 12, 13, 14, 15, 16, 17, 18, 19, 20, 21 or 22;
(E)-Δ6 desaturated fatty aldehydes having a carbon chain length of 8, 9, 10, 11, 12, 13, 14, 15, 16, 17, 18, 19, 20, 21 or 22;
(Z)-Δ7 desaturated fatty aldehydes having a carbon chain length of 8, 9, 10, 11, 12, 13, 14, 15, 16, 17, 18, 19, 20, 21 or 22;
(E)-Δ7 desaturated fatty aldehydes having a carbon chain length of 8, 9, 10, 11, 12, 13, 14, 15, 16, 17, 18, 19, 20, 21 or 22;
(Z)-Δ8 desaturated fatty aldehydes having a carbon chain length of 9, 10, 11, 12, 13, 14, 15, 16, 17, 18, 19, 20, 21 or 22;
(E)-Δ8 desaturated fatty aldehydes having a carbon chain length of 9, 10, 11, 12, 13, 14, 15, 16, 17, 18, 19, 20, 21 or 22;
(Z)-Δ9 desaturated fatty aldehydes having a carbon chain length of 10, 11, 12, 13, 14, 15, 16, 17, 18, 19, 20, 21 or 22;
(E)-Δ9 desaturated fatty aldehydes having a carbon chain length of 10, 11, 12, 13, 14, 15, 16, 17, 18, 19, 20, 21 or 22;
(Z)-Δ10 desaturated fatty aldehydes having a carbon chain length of 11, 12, 13, 14, 15, 16, 17, 18, 19, 20, 21 or 22;
(E)-Δ10 desaturated fatty aldehydes having a carbon chain length of 11, 12, 13, 14, 15, 16, 17, 18, 19, 20, 21 or 22;
(Z)-Δ11 desaturated fatty aldehydes having a carbon chain length of 12, 13, 14, 15, 16, 17, 18, 19, 20, 21 or 22;
(E)-Δ11 desaturated fatty aldehydes having a carbon chain length of 12, 13, 14, 15, 16, 17, 18, 19, 20, 21 or 22;
(Z)-Δ12 desaturated fatty aldehydes having a carbon chain length of 13, 14, 15, 16, 17, 18, 19, 20, 21 or 22;
(E)-Δ12 desaturated fatty aldehydes having a carbon chain length of 13, 14, 15, 16, 17, 18, 19, 20, 21 or 22;
(Z)-Δ13 desaturated fatty aldehydes having a carbon chain length of 14, 15, 16, 17, 18, 19, 20, 21 or 22; and
(E)-Δ13 desaturated fatty aldehydes having a carbon chain length of 14, 15, 16, 17, 18, 19, 20, 21 or 22.

In some embodiments, the fatty aldehydes are desaturated fatty aldehydes having a carbon chain length of 12, such as:
(Z)-Δ5 desaturated fatty aldehydes having a carbon chain length of 12;
(E)-Δ5 desaturated fatty aldehydes having a carbon chain length of 12;
(Z)-Δ6 desaturated fatty aldehydes having a carbon chain length of 12;
(E)-Δ6 desaturated fatty aldehydes having a carbon chain length of 12;
(Z)-Δ7 desaturated fatty aldehydes having a carbon chain length of 12;
(E)-Δ7 desaturated fatty aldehydes having a carbon chain length of 12;
(Z)-Δ8 desaturated fatty aldehydes having a carbon chain length of 12;
(E)-Δ8 desaturated fatty aldehydes having a carbon chain length of 12;
(Z)-Δ9 desaturated fatty aldehydes having a carbon chain length of 12;
(E)-Δ9 desaturated fatty aldehydes having a carbon chain length of 12;
Z)-Δ10 desaturated fatty aldehydes having a carbon chain length of 12;
(E)-Δ10 desaturated fatty aldehydes having a carbon chain length of 12;
(Z)-Δ11 desaturated fatty aldehydes having a carbon chain length of 12; and
(E)-Δ11 desaturated fatty aldehydes having a carbon chain length of 12.

In some embodiments, the fatty aldehydes are desaturated fatty aldehydes having a carbon chain length of 14, such as:
(Z)-Δ5 desaturated fatty aldehydes having a carbon chain length of 14;
(E)-Δ5 desaturated fatty aldehydes having a carbon chain length of 14;
(Z)-Δ6 desaturated fatty aldehydes having a carbon chain length of 14;
(E)-Δ6 desaturated fatty aldehydes having a carbon chain length of 14;
(Z)-Δ7 desaturated fatty aldehydes having a carbon chain length of 14;
(E)-Δ7 desaturated fatty aldehydes having a carbon chain length of 14;
(Z)-Δ8 desaturated fatty aldehydes having a carbon chain length of 14;
(E)-Δ8 desaturated fatty aldehydes having a carbon chain length of 14;
(Z)-Δ9 desaturated fatty aldehydes having a carbon chain length of 14;
(E)-Δ9 desaturated fatty aldehydes having a carbon chain length of 14;
(Z)-Δ10 desaturated fatty aldehydes having a carbon chain length of 14;
(E)-Δ10 desaturated fatty aldehydes having a carbon chain length of 14;
(Z)-Δ11 desaturated fatty aldehydes having a carbon chain length of 14;
(E)-Δ11 desaturated fatty aldehydes having a carbon chain length of 14;
(Z)-Δ12 desaturated fatty aldehydes having a carbon chain length of 14;
(E)-Δ12 desaturated fatty aldehydes having a carbon chain length of 14;
(Z)-Δ13 desaturated fatty aldehydes having a carbon chain length of 14; and
(E)-Δ13 desaturated fatty aldehydes having a carbon chain length of 14.

In some embodiments, the fatty aldehydes are desaturated fatty aldehydes having a carbon chain length of 16, such as:
(Z)-Δ5 desaturated fatty aldehydes having a carbon chain length of 16;
(E)-Δ5 desaturated fatty aldehydes having a carbon chain length of 16;
(Z)-Δ6 desaturated fatty aldehydes having a carbon chain length of 16;
(E)-Δ6 desaturated fatty aldehydes having a carbon chain length of 16;
(Z)-Δ7 desaturated fatty aldehydes having a carbon chain length of 16;
(E)-Δ7 desaturated fatty aldehydes having a carbon chain length of 16;
(Z)-Δ8 desaturated fatty aldehydes having a carbon chain length of 16;
(E)-Δ8 desaturated fatty aldehydes having a carbon chain length of 16;
(Z)-Δ9 desaturated fatty aldehydes having a carbon chain length of 16;
(E)-Δ9 desaturated fatty aldehydes having a carbon chain length of 16;
(Z)-Δ10 desaturated fatty aldehydes having a carbon chain length of 16;
(E)-Δ10 desaturated fatty aldehydes having a carbon chain length of 16;
(Z)-Δ11 desaturated fatty aldehydes having a carbon chain length of 16;
(E)-Δ11 desaturated fatty aldehydes having a carbon chain length of 16;
(Z)-Δ12 desaturated fatty aldehydes having a carbon chain length of 16;
(E)-Δ12 desaturated fatty aldehydes having a carbon chain length of 16;
(Z)-Δ13 desaturated fatty aldehydes having a carbon chain length of 16; and
(E)-Δ13 desaturated fatty aldehydes having a carbon chain length of 16.

For example, the fatty aldehyde is an (E) 7, (Z) 9 desaturated fatty aldehyde having a carbon chain length of 10, 11, 12, 13, 14, 15, 16, 17, 18, 19, 20, 21 or 22. In some embodiments, the fatty aldehyde is an (E) 3, (Z) 8, (Z) 11 desaturated fatty aldehyde having a carbon chain length of 12, 13, 14, 15, 16, 17, 18, 19, 20, 21 or 22, for example 14. In some embodiments, the fatty aldehyde is a (Z) 9, (E) 11, (E) 13 desaturated fatty aldehyde having a carbon chain length of 14, 15, 16, 17, 18, 19, 20, 21 or 22. In some embodiments, the fatty aldehyde is a (Z) 11, (Z) 13 desaturated fatty aldehyde having a carbon chain length of 14, 15, 16, 17, 18, 19, 20, 21 or 22. In some embodiments, the fatty aldehyde is a (Z) 9, (E) 12 desaturated fatty aldehyde having a carbon chain length of 13, 14, 15, 16, 17, 18, 19, 20, 21 or 22. In some embodiments, the fatty aldehyde is a (E) 7, (E) 9 desaturated fatty aldehyde having a carbon chain length of 10, 11, 12, 13, 14, 15, 16, 17, 18, 19, 20, 21 or 22. In some embodiments, the fatty aldehyde is a (E) 8, (E) 10 desaturated fatty aldehyde having a carbon chain length of 11, 12, 13, 14, 15, 16, 17, 18, 19, 20, 21, or 22.

In other embodiments, the fatty aldehyde is an (E) 7, (Z) 9 desaturated fatty aldehyde having a carbon chain length of 14. In other embodiments, the desaturated fatty aldehyde is an (E) 3, (Z) 8, (Z) 11 desaturated fatty aldehyde having a carbon chain length of 14. In other embodiments, the desaturated fatty aldehyde is a (Z) 9, (E) 11, (E) 13 desaturated fatty aldehyde having a carbon chain length of 14. For example, the fatty aldehyde is an (E) 7, (Z) 9 desaturated fatty aldehyde having a carbon chain length of 12. In other embodiments, the desaturated fatty aldehyde is an (E) 3, (Z) 8, (Z) 11 desaturated fatty aldehyde having a carbon chain length of 12. In other embodiments, the desaturated fatty aldehyde is a (Z) 9, (E) 11, (E) 13 desaturated fatty aldehyde having a carbon chain length of 12. In other embodiments, the desaturated fatty aldehyde is a (E) 8, (E) 10 desaturated fatty aldehyde having a carbon chain length of 12. In other embodiments, the desaturated fatty aldehyde is a (E) 7, (E) 9 desaturated fatty aldehyde having a carbon chain length of 11. In other embodiments, the desaturated fatty aldehyde is a (Z) 11, (Z) 13 desaturated fatty aldehyde having a carbon chain length of 16. In other embodiments, the desaturated fatty aldehyde is a (Z) 9, (E) 12 desaturated fatty aldehyde having a carbon chain length of 14

In some embodiments the fatty aldehyde is (Z9, E12)-tetradecadien-1-al. Microbial cell factories and methods for obtaining the corresponding alcohol (Z9, E12)-tetradecadien-1-ol from a yeast cell are described in detail in application EP21183447.8 entitled “Methods and yeast cells for production of desaturated compounds” filed on 2 Jul. 2021 by same applicant.

In some embodiments the fatty aldehyde is (Z11, Z13)-hexadecadien-1-al. Microbial cell factories and methods for obtaining the corresponding alcohol (Z11, Z13)-hexadecadien-1-ol from a yeast cell are described in detail in application EP21183459.3 entitled “Methods and yeast cells for production of desaturated compounds” filed on 2 Jul. 2021 by same applicant.

In some embodiments the fatty aldehyde is (E8, E10)-dodecadien-1-al. Microbial cell factories and methods for obtaining the corresponding alcohol (E8,E10)-hexadecadien-1-ol from a yeast cell are described in detail in application WO 2021/123128.

In some embodiments the fatty aldehyde is (Z11)-hexadecen-1-al. Microbial cell factories and methods for obtaining the corresponding alcohol (Z11)-hexadecen-1-ol from a yeast cell are described in detail in application WO 2016/207339. This alcohol can be converted to (Z11)-hexadecen-1-al using the method disclosed herein.

In a special embodiment of the disclosure, the fatty aldehyde has a double bond at position 9, 11, or 13, or double bonds at positions 9 and 11 or at positions 11 and 13; or the fatty aldehyde has a double bond at position 9 or 12, or double bonds at positions 9 and 12. In an even more special embodiment of the disclosure, the fatty aldehyde has a chain length of 12 and a double bond at position 9 or 11, or double bonds at positions 9 and 11; or the fatty aldehyde has a chain length of 14 and a double bond at position 9 or 12, or double bonds at positions 9 and 12; or the fatty aldehyde has a chain length of 14 and a double bond at position 9, 11, or 13, or double bounds at positions 9 and 11, or at positions 11 and 13. In another more special embodiment of the disclosure, the fatty aldehyde has a chain length of 14 and a double bond at position 9 or 11, or double bonds at positions 9 and 11. In another more special embodiment of the disclosure, the fatty aldehyde has a chain length of 16 and a double bond at position 9 or 11, or double bonds at positions 9 and 11. In other embodiments, the fatty aldehyde has a chain length of 16 and a double bond at position 11 or 13, or double bonds at positions 11 and 13. In other embodiments, the fatty aldehyde has a chain length of 12 and a double bond at position 8 or 10, or double bonds at positions 8 and 10.

In a specific embodiment, the fatty aldehyde is selected from the group consisting of tetradecan-1-al, pentadecan-1-al, hexadecan-1-al, pentadecen-1-al, (Z)-9-hexadecen-1-al, (Z)-11-hexadecen-1-al, (7E,9E)-undeca-7,9-dien-1-al, (11Z,13Z)-hexadecadien-1-al, (9Z,12E)-tetradecadien-1-al, and (8E,10E)-dodecadien-1-al.

In a particular embodiment, the fatty aldehyde is (Z)-11-hexadecenal or (Z)-9-tetradecenal.

The fatty aldehyde can be in a composition which consist entirely of fatty aldehydes, or it may comprise fatty aldehydes and other compounds. In one embodiment of the disclosure, such fatty aldehyde composition comprises 5 to 10 wt % of one or more fatty aldehydes. In another embodiment, the fatty aldehyde composition comprises 10 to 20 wt % of one or more fatty aldehydes. In another embodiment, the fatty aldehyde composition comprises 20 to 30 wt % of one or more fatty aldehydes.

In another embodiment, the fatty aldehyde composition comprises 30 to 40 wt % of one or more fatty aldehydes. In another embodiment, the fatty aldehyde composition comprises 40 to 50 wt % of one or more fatty aldehydes. In another embodiment, the fatty aldehyde composition comprises 50 to 60 wt % of one or more fatty aldehydes. In another embodiment, the fatty aldehyde composition comprises 60 to 70 wt % of one or more fatty aldehydes. In another embodiment, the fatty aldehyde composition comprises 70 to 80 wt % of one or more fatty aldehydes. In another embodiment, the fatty aldehyde composition comprises 80 to 90 wt % of one or more fatty aldehydes.

In another embodiment, the fatty aldehyde composition comprises 90 to 100 wt % of one or more fatty aldehydes. In a special embodiment of the disclosure, the fatty aldehyde composition comprises in the range of 50 to 100% of one or more fatty aldehyde. In an even more special embodiment, the fatty aldehyde composition comprises in the range of 60 to 100% of one or more fatty aldehydes.

In one embodiment of the disclosure, the fatty aldehyde composition comprises at least 30 wt % of one or more fatty aldehydes. In another embodiment, the fatty aldehyde composition comprises at least 35 wt % of one or more fatty aldehydes. In another embodiment, the fatty aldehyde composition comprises at least 40 wt % of one or more fatty aldehydes. In another embodiment, the fatty aldehyde composition comprises at least 45 wt % of one or more fatty aldehydes. In another embodiment, the fatty aldehyde composition comprises at least 50 wt % of one or more fatty aldehydes. In another embodiment, the fatty aldehyde composition comprises at least 55 wt % of one or more fatty aldehydes. In another embodiment, the fatty aldehyde composition comprises at least 60 wt % of one or more fatty aldehydes. In a special embodiment, the fatty aldehyde composition comprises at least 70 wt % of one or more fatty aldehydes. In another special embodiment, the fatty aldehyde composition comprises at least 80 wt % of one or more fatty aldehydes. In another special embodiment, the fatty aldehyde composition comprises at least 90 wt % of one or more fatty aldehydes.

In additional or alternative embodiments, the fatty aldehyde is an aliphatic fatty aldehyde. Such fatty aldehydes and/or alcohols can comprise 5 to 20 carbons, such as 9 to 18 carbons, such as 12 to 18 carbons. In particularly attractive embodiments the number of carbon in the aliphatic aldehydes and/or alcohol is 12, 14, 16, or 18 carbons. The aldehyde group is suitably located at C1 in the aldehyde. In other embodiments the aldehyde is unsaturated and comprises one or more double bonds. Particularly attractive aldehydes have a double bond at position 9 ((Z)-9) and/or at position 11 ((Z)-11). Specific aldehydes of interest comprise 12, 14, 16 or 18 carbons and have double bonds at position 9 and/or at position 11 and these are of particular interest, because such aldehydes can have pheromone properties and can be a non-toxic mean for monitoring, regulating and/or controlling pests sensitive to such pheromones in crop fields. In further additional or alternative embodiments, the aldehyde comprises two or three or more different aldehydes. In particular the aldehyde is a pheromone, such as an insect pheromone.

In some embodiments, the aldehyde and/or alcohol comprises 16 carbons and has a double bond at position 9 and/or at position 11. In some embodiments, the method comprises protecting a plurality of fatty aldehydes, a plurality of fatty alcohols, and/or a combination thereof. In some embodiments, the plurality of fatty aldehydes and/or alcohols comprises two or three or more different aldehydes and/or alcohols. In some embodiments, the fatty aldehyde and/or fatty alcohol is a pheromone.

### Protective Agents

The protective agent described herein comprises a sulfur containing compound. The sulfur in the protective agent can be conjugated or unconjugated, for example the sulfur in the protective agent can be a conjugated sulfur. In some embodiments, the protective agent comprises a thiol, which can be a heterocyclic thiol and/or an aromatic thiol. In more specific embodiments, the protective agent comprises a compound selected from zinc pyrithione, 5-amino-1,3,4-thiadiazole-2-thiol, 2-thiazoline-2-thiol, 5-methyl-1,3,4-thiadiazole-2-thiol, 2-mercapto-benzimidazole, 2-mercapto-1-methylimidazole and sodium pyrithione.

The aldehyde and/or alcohol is suitably contacted with the protective agent by mixing the aldehyde and/or alcohol with the protective agent into a composition.

In some embodiments, the protective agent is a corrosion inhibitor. Corrosion inhibitors may in some embodiments indirectly help to stabilize aldehydes by preventing for example metal ions from catalyzing the degradation of aldehydes. In some embodiments, the protective agent comprises a sulfur containing compound and is a corrosion inhibitor. In some embodiments, the corrosion inhibitor is a compound selected from zinc pyrithione, 5-amino-1,3,4-thiadiazole-2-thiol, 2-thiazoline-2-thiol, 5-methyl-1,3,4-thiadiazole-2-thiol, 2-mercapto-benzimidazole, 2-mercapto-1-methylimidazole and sodium pyrithione.

### Stabilizers

In some embodiments, the protective agent described herein is used in combination with one or more stabilizers, such as a stabilizer selected from the group consisting of: an antioxidant, a radical scavenger, a pH regulator, a buffer, a UV stabilizer, a chelator, and any combination thereof. In some embodiments, the stabilizer is selected from the group consisting of: Sumisorb (CAS 3896-11-5); BHT (CAS 109-99-9), TBHQ (CAS 1948-33-0), Tocopherol (CAS 10191-41-0), Dimethylethanolamine (CAS 287476-09-9), Tinuvin 770 (CAS 52829-07-9), Tinuvin P (CAS 2440-22-4), Morpholine (CAS 110-91-8), Sodium Hydroxide (CAS 1310-73-2), Propyl Gallate (CAS 121-79-9), BHA (CAS 121-00-6), and any combination thereof. Accordingly, in some embodiments the protective agent is sodium pyrithione used in combination with a stabilizer disclosed herein.

The stabilizers that can be used in combination with the protective agents of the present disclosure can stabilize using one or more mechanisms, such as by acting as an antioxidant, a radical scavenger, a pH regulator, a buffer, a UV stabilizer, a chelator, or any combination thereof.

The present protective agents disclosed herein can be used in combination with one or more of the following stabilizers, the effects of which are outlined in the table below:

| | | | Stabilizing effect | | | |
|---|---|---|---|---|---|---|
| # | | CAS | UV | Antioxidant | Complexing | pH Regulating |
| 0 | Blank | | | | | |
| 1 | Sumisorb | 3896-11-5 | X | X | X | |
| 2 | BHT | 109-99-9 | | X | | |
| 3 | TBHQ | 1948-33-0 | | X | | |
| 4 | Tocopherol | 10191-41-0 | | X | | |
| 5 | Dimethylethanolamine | 287476-09-9 | | | X | X |
| 6 | Glycerol | 56-81-5 | | | X | |
| 7 | Sodium pyrithione | 15922-78-8 | | | X | |
| 8 | Tinuvin 770 | 52829-07-9 | X | | | |
| 9 | Tinuvin P | 2440-22-4 | | | | |
| 10 | Morpholine | 110-91-8 | | | | X |
| 11 | Sodium Hydroxide | 1310-73-2 | | | | X |
| 12 | DMSO | 67-68-5 | | | X | |
| 13 | Sulfolane | 126-33-0 | | | X | |
| 14 | Propyl Gallate | 121-79-9 | | X | X | |
| 15 | BHA | 121-00-6 | | X | | |

### Compositions

A further aspect described herein is a composition comprising the aldehyde and/or an alcohol and the protective agent as described, supra, wherein the the protective agent protects the aldehyde and/or an alcohol from oxidation and/or from being converted into an acid. In some embodiments, the protective agents protects the aldehyde and/or alcohol of the present disclosure from degradation.

In some embodiments, the degradation occurs by one or more proccesses selected from: oxidation, aldol reaction, aldol condensation, hemiacetal, acetal formation, Cannizarro Reaction and Tishchenko Reaction.

In some embodiments, the degradation occurs by oxidation.

In some embodiments, the degradation occurs by oxidation of the fatty aldehyde and/or fatty alcohol of the present disclosure into an acid.

Such composition can further comprise one or more additional carriers, agents, additives and/or excipients. In some embodiments the composition comprises 10 mg or more of the protective agent per gram aldehyde and/or alcohol, such as 20 mg or more, such as 30 mg or more, such as 50 mg or more, such as 100 mg or more. Additionally or alternatively the composition can comprising at least 0.5% wt of aldehyde and/or alcohol, such as at least 1.0% wt, such as at least 1.5% wt, such as at least 3.0% wt, such as at least 5.0% wt, such as at least 10.0% wt, such as at least 25.0% wt.

Further, such composition can comprise compounds such as oxidants, catalysts, ligands and/or bases or a combination thereof promoting oxidation. Such compounds may be residues from processes in which the aldehyde and/or alcohol was made.

In some embodiments, the catalyst comprises an aminoxyl radical compound, i.e. a compound having a N—O* functional group. In a further embodiment of the present disclosure, the aminoxyl radical compound is a dialkyl aminoxyl radical compound. In further embodiments, the aminoxyl radial compound is piperidine N-oxide or a derivative thereof. In still further embodiments, the aminoxyl radical compound is a substituted piperidine N-oxide. In still further embodiments, the aminoxyl radical compound is (2,2,6,6-tetramethylpiperidin-1-yl)oxyl (TEMPO) or a derivative thereof. In some embodiments, the aminoxyl radical compound is selected from the group consisting of TEMPO, (4-hydroxy-2,2,6,6-tetramethylpiperidin-1-yl)oxyl (4-OH-TEMPO), 4-acetamido-TEMPO, 4-hydroxy-TEMPO benzoate, 4-amino-TEMPO, 2-azaadamantane-N-oxyl, 9-azabicyclo[3.3.1]nonane N-oxyl, 4-carboxy-TEMPO, 4-maleimido-TEMPO, 4-methoxy-TEMPO, 1-methyl-2-azaadamantane-N-oxyl, 4-oxo-TEMPO, and a polymer functionalised with any of said aminoxyl radical compounds. In a special embodiment of the present disclosure, the aminoxyl radical compound is selected from the group consisting of TEMPO or (4-hydroxy-2,2,6,6-tetramethylpiperidin-1-yl)oxyl (4-OH-TEMPO). It is contemplated that the aminoxyl radical compound is part of the catalytic cycle which effect oxidation of the fatty alcohol composition of the present disclosure. It is acknowledged that TEMPO and its derivatives described herein act as catalysts for oxidation while the oxidant is O₂. However, as used herein, TEMPO and the derivatives may also be considered “oxidants”.

In additional or alternative embodiments the catalyst comprises a copper(I) source, such as for example a copper(I) salt. The copper(I) source is a substance or mixtures of substances containing a copper(I) compound. Examples include, among others, copper(I) chloride, copper(I) bromide, copper(I) iodide, copper(I) cyanide, copper(I) oxide, copper(I) trifluoromethanesulfonate, tetrakis(acetonitrile) copper(I) tetrafluoroborate, tetrakis(acetonitrile) copper(I) tetraphenylborate, tetrakis(acetonitrile) copper(I) hexafluorophosphate, tetrakis(acetonitrile) copper(I) trifluoromethanesulfonate, copper(I) sulfide, copper(I) thiocyanate, Cu[1,3-bis(2,6-diisopropylphenyl) imidazol-2-ylidene]Cl, Cu[1,3-bis(2,6-diisopropylphenyl) imidazol-2-ylidene]Br, CuBr (1,10-phenanthroline)₂, CuCl(1,10-phenanthroline)]₂, CuI (1,10-phenanthroline)₂, copper(I) trifluoroacetate, [Cu(PPh₃)₃]Br, [Cu(PPh₃)₃]F, [Cu(PPh₃)₃]Cl, Cu(OCOR²), Cu(SR²), Cu(SR²₂) Br, Cu(SR²₂)Cl, Cu(SR²₂)I, Cu(OSO₂R²), CuOR², wherein R² is selected from alkyl, preferably C₁-C₂₀ alkyl, optionally substituted with one or more aryl, alkoxy and aryloxy and from aryl, preferably C₅-C₇ aryl, optionally substituted with one or more alkyl, aryl, alkoxy and aryloxy and mixtures thereof. In addition, the copper(I) source can be a substance or mixtures of substances containing copper in any other oxidation state, provided it can be converted to copper in the oxidation state of +1 by means of reduction or oxidation, either chemically or electrochemically. In a special embodiment, the copper(I) source comprises copper present in oxidation state of +1.

In a special embodiment, the composition also comprises a counter ion to the copper(I) source, i.e. a negatively charged ion, such as triflate, tetrafluoroborate, hexafluorophosphate, or halides.

The composition can further comprise ligands coordinated to a copper catalyst including but not limited to tetrakisacetonitrile copper(I) triflate, tetrakisacetonitrile copper(I) tetrafluoroborate, tetrakisacetonitrile copper(I) hexafluorophosphate, tetrakisacetonitrile copper(I) halide, CuBr(1,10-phenanthroline)₂, CuCl(1,10-phenanthroline)]₂, and CuCl(1,10-phenanthroline)₂. In some embodiments the catalyst is from the group of tetrakisacetonitrile copper(I) triflate, tetrakisacetonitrile copper(I) tetrafluoroborate, tetrakisacetonitrile copper(I) hexafluorophosphate, and tetrakisacetonitrile copper(I) halide.

In other embodiments the catalyst can comprise a copper(II) compound and a reductant capable of reducing the copper (ii) to copper(I). In addition the composition can comprise a counter ion to Cu(II). Accordingly, in some embodiments, the catalyst is selected from the group of copper(II) triflate, copper(II) tetrafluoroborate, copper(II) hexafluorophosphate, copper(II) bromide, copper(II) chloride, copper(II) iodide, and copper(II) perchlorate. The reductant is capable of reducing copper(II) to copper(I) and can be either of an organic or an inorganic reductant. In one embodiment, the reductant is selected from the group consisting of copper metal, zinc metal, aluminium metal, sodium hydrogensulfite, formic acid, salts of formic acid, oxalic acid, and salts of oxalic acid. The metal-based reductants may advantageously be on powder, pellet, shavings, or otherwise finely divided form.

Where the composition described herein comprises a ligand coordinated to copper(I), such ligands can coordinate to Cu(I) via nitrogen, oxygen, phosphorous, or other atoms having a lone-pair, such as via a moiety selected from the group consisting of pyridine, triarylphosphine, diarylphosphine, amine, imidazole, pyrazole, pyrrole, triazole, tetrazole, imine, enamine, phenol. Additionally or alternatively ligand may be a monodentate, bidendate or a polydentate ligand, such as a polydentate ligand coordinating with 3 or more atoms. The ligand can comprise a single type of ligand a mixture of two or more types of ligands. More specifically ligand can be from the group of DETA, PMDETA, TETA, HMTETA, Me₆TREN, cyclam, Me₆cyclam, DMCBCy, bpy, dNbpy, 1,10-Phen, tpy, tNtpy, BPMPrA, BPMOA, BPMODA, TPMA, and TPEA. In other embodiments the ligand is a secondary amine, such as a secondary amine having bulky substituents (i.e. to reduce nucleophilicity of the amine). In one embodiment of the present disclosure, the ligand is a bidentate nitrogen ligand. In one embodiment, the ligand comprises a 2,2′-bipyridine moiety or a 2,2′-bipyrimidine moiety. In addition or alternatively the ligand can be from the group of 4,4′-dimethyl-2,2′-bipyridine, 5,5′-dimethyl-2,2′-bipyridine 2,2′-bipyrimidine, 2,2′-bipyridine-4,4′-dicarboxylic acid or an ester thereof, 2,2′-bipyridine-5,5′-dicarboxylic acid or an ester thereof.

In addition or alternatively the composition can also comprise a base including a nitrogen base, such as a Schiff base or an oxygen base. Such bases would include those selected from In one embodiment of the present disclosure, the base is selected from the group consisting of 1-methylimidazole, 1,8-diazabicyclo[5.4.0]undec-7-ene, 1,5-diazabicyclo[4.3.0]non-5-ene, 1,5,7-triazabicyclo[4.4.0]dec-5-ene, 1,1,3,3-tetramethylguanidine, 7-methyl-1,5,7-triazabicyclo[4.4.0]dec-5-ene, and potassium t-butoxide. In one embodiment of the present disclosure, the base is selected from the group consisting of: 1-methyl imidazole, potassium tert-butoxide, or 1,8-diazabicyclo(5.4.0) undec-7-ene (DBU).

In still further embodiments the composition described herein can comprise a carrier facilitating controlled, slow and/or delayed release of the aldehyde and/or alcohol. Such carrier can suitably be a polymeric substrate or microporous solid. Suitable polymeric substrates include one or more substances selected from plastic, wax emulsion, oil emulsion, microcapsules or microparticles. Interesting microparticles for this purpose is described for example in U.S. Pat. No. 10,271,547 while other interesting polymeric substrates are described in US2008/0254083. Suitable microporous solids includes zeolite such as described in Munoz-Pallares et al; J. Agric. Food Chem. 2001, 49, 4801-4807.

In some embodiments, the compositions provided comprise copper (Cu), such as Cu⁺ and or Cu²⁺. In some embodiments, the composition comprises 40 ppm Cu or less. In some embodiments, the composition comprises from 10 ppm to 40 ppm Cu, for example from 10 ppm to 30 ppm, such as from 10 ppm to 20 ppm, for example 10 ppm.

### Methods of Use

A further aspect described herein is a method for controlling or monitoring a pest wherein the composition described herein is distributed into a (pest infested) habitat for the pest and allowing the protected aldehyde and/or alcohol to control the pest. Such a (pest infested) habitat is suitably an agricultural field or a forrest or any other habitat infested with a pest or sensitive to become infested with a pest. Pest which are sensitive to being controlled or monitored by the said method is typically an arthropod, such as an insect, or other animals using aldehydes and/or alcohols for triggering a social response in members of the same or similar species.

### Further Itemized Embodiments

Further described herein are the following itemized embodiments:

Item 1. A method for protecting an aldehyde and/or an alcohol from oxidation and/or from being converted into an acid comprising contacting said aldehyde and/or alcohol with a protective agent comprising a sulfur containing compound.

Item 2. The method of item 1, wherein aldehyde and/or alcohol is a fatty aldehyde and/or alcohol.

Item 3. The method of any preceding item, wherein the fatty aldehyde and/or alcohol is an aliphatic fatty aldehyde and/or alcohol.

Item 4. The method of item 2 to 3, wherein the fatty aldehyde and/or alcohol comprises 5 to 20 carbons, such as 9 to 18 carbons, such as 12 to 18 carbons, such as 12, 14, 16, or 18 carbons.

Item 5. The method of any preceding item, wherein the aldehyde and/or alcohol group is a C1 aldehyde and/or C1 alcohol.

Item 6. The method of any preceding item, wherein the aldehyde and/or alcohol is unsaturated and comprises one or more double bonds.

Item 7. The method of any preceding item, wherein the aldehyde and/or alcohol has a double bond at position 9 ((Z)-9) and/or at position 11 ((Z)-11).

Item 8. The method of any preceding item, wherein the aldehyde and/or alcohol comprises 16 carbons and has a double bond at position 9 and/or at position 11.

Item 9. The method of any preceding item, wherein the aldehyde and/or alcohol comprises two or three or more different aldehydes and/or alcohols.

Item 10. The method of any preceding item, wherein the aldehyde and/or alcohol is a pheromone.

Item 11. The method of item 10, wherein pheromone is an arthropod pheromone, optionally an insect pheromone.

Item 12. The method of any preceding item, wherein the sulfur in the protective agent is a conjugated sulfur.

Item 13. The method of any preceding item, wherein the protective agent comprises a thiol.

Item 14. The method of item 13, wherein the thiol is a heterocyclic thiol.

Item 15. The method of item 13, wherein the thiol is an aromatic thiol.

Item 16. The method of any preceding item, wherein the protective agent comprises a compound selected from zinc pyrithione, 5-amino-1,3,4-thiadiazole-2-thiol, 2-thiazoline-2-thiol, 5-methyl-1,3,4-thiadiazole-2-thiol, 2-mercapto-benzimidazole, 2-mercapto-1-methylimidazole and sodium pyrithione.

Item 17. The method of any preceding item, wherein the aldehyde and/or alcohol is contacted with the protective agent by mixing the aldehyde and/or alcohol with the protective agent into a composition.

Item 18. A composition comprising an aldehyde and/or an alcohol and a protective agent comprising a sulfur containing compound, which protects an aldehyde and/or an alcohol from oxidation and/or from being converted into an acid.

Item 19. The composition of item 18, further comprising one or more additional carriers, agents, additives and/or excipients.

Item 20. The composition of item 18 to 19, wherein the aldehyde and/or alcohol is the aldehyde and/or alcohol of items 5 to 11.

Item 21. The composition of item 18 to 20, wherein the protective agent is the protective agent of items 12 to 16.

Item 22. The composition of item 18 to 21, comprising at least 10 mg of the protective agent per gram aldehyde and/or alcohol.

Item 23. The composition of item 18 to 22, comprising at least 0.5% wt of aldehyde and/or alcohol.

Item 24. The composition of item 18 to 23, further comprising an oxidant or a catalyst promoting oxidation.

Item 25. The composition of item 24, wherein the oxidant is 4-hydroxy-TEMPO.

Item 26. The composition of item 24, wherein the catalyst comprises Cu.

Item 27. The composition of item 18 to 26, further comprising a carrier facilitating slow release of the aldehyde and/or alcohol.

Item 28. The composition of item 27, wherein the carrier is a polymeric substrate or microporous solid.

Item 29. The composition of item 28, wherein the polymeric substrate is one or more substances selected from plastic, wax emulsion, oil emulsion, or microcapsules.

Item 30. The composition of item 28, wherein the microporous solid is a zeolite.

Item 31. A method of controlling or monitoring a pest comprising distributing the composition of item 18 to 30 in a habitat for the pest and allowing the protected aldehyde and/or alcohol control the pest.

Item 32. The method of item 31, wherein the habitat is an agricultural field, and the pest is an insect.

### EXAMPLES

### Example 1

To a mixture of aldehydes containing; (Z)-9-hexadecenal, (Z)-11-hexadecenal, hexadecanal, (Z)-11-hexadecen-1-ol, (Z)-11-hexadecenoic acid and 40 ppm Cu was added an additive as indicated in table 1 below. The mixture was thoroughly mixed and heated without cap in an oven at 55° C. for 14 days as an accelerated storage test. As can be seen in table 1, for the sample without additive the concentration of aldehydes has decreased significantly while the concentration of (Z)-11-hexadecenoic acid has increased. Surprisingly a number of compounds and in particular sodium pyrithione were particularly efficient at suppressing degradation.

TABLE 1

| Wt | | | | | | | |
|---|---|---|---|---|---|---|---|
| aldehyde | | | Wt | | | | |
| sample | Additive | | Additive | | Z11- | | |
| (g) | Cas Nr | Additive Name | (mg) | Z9-16:Ald | 16Ald | 16:Ald | C16:Acid |
| | | Before Test | 0 | 4.3 | 69.4 | 7.5 | 6.7 |
| 4.25 | | Blank | 0 | 3.066023 | 54.83784 | 6.659339 | 18.84135 |
| 4.25 | 3896-11-5 | Sumisorb | 4.25 | 3.324593 | 52.4909 | 6.835157 | 17.10425 |
| 4.25 | 109-99-9 | BHT | 8.5 | 3.425354 | 54.06433 | 6.958469 | 16.04514 |
| 4.25 | 1948-33-0 | TBHQ | 4.25 | 3.36653 | 53.68629 | 6.912739 | 16.51531 |
| 4.25 | 10191-41-0 | Tocopherol | 21.25 | 3.379038 | 54.66676 | 6.913684 | 17.008 |
| 4.25 | 287476-09-9 | Dimethylethanolamine | 4.25 | 0 | 8.127664 | 1.242208 | 11.54753 |
| 4.25 | 56-81-5 | Glycerol | 100 | 3.114673 | 54.85748 | 6.735612 | 18.83107 |
| 4.25 | 15922-78-8 | Sodium pyrithione | 21.25 | 3.082588 | 57.02293 | 6.67533 | 8.923698 |
| 4.25 | 52829-07-9 | Tinuvin 770 | 4.25 | 3.135457 | 55.81169 | 6.749344 | 18.22293 |
| 4.25 | 2440-22-4 | Tinuvin P | 4.25 | 3.085387 | 54.34599 | 6.633749 | 19.1541 |
| 4.25 | 110-91-8 | Morpholine | 4.25 | 2.254739 | 40.03448 | 4.754765 | 12.35465 |
| 4.25 | 1310-73-2 | Sodium Hydroxide | 0.425 | 2.927441 | 51.62158 | 6.224089 | 16.74294 |
| 4.25 | 67-68-5 | DMSO | 100 | 3.060853 | 55.24058 | 6.721726 | 19.16974 |
| 4.25 | 126-33-0 | Sulfolane | 100 | 3.07652 | 54.90673 | 6.666142 | 18.34015 |
| 4.25 | 121-79-9 | Propyl Gallate | 4.25 | 3.46419 | 61.55221 | 7.37599 | 14.55242 |
| 4.25 | 121-00-6 | BHA | 4.25 | 3.364231 | 59.48063 | 7.157968 | 15.55346 |

### Example 2

To a mixture of aldehydes containing; (Z)-9-hexadecenal, (Z)-11-hexadecenal, hexadecanal, (Z)-11-hexadecen-1-ol, (Z)-11-hexadecenoic acid and 10 ppm Cu in the composition listed in table 2 below was added of an additive in table below. The mixture was thoroughly mixed and heated without cap in an oven at 55° C. for 14 days as an accelerated storage test. As can be seen in the table, for the sample without additive the concentration of aldehydes has decreased significantly while the concentration of (Z)-11-hexadecenoic acid has increased. Surprisingly, a number of compounds and in particular sodium pyrithione were highly efficient at suppressing degradation.

TABLE 2

| Wt aldehyde | | | | | | | |
|---|---|---|---|---|---|---|---|
| sample | Additive | | Wt Additive | | | | |
| (g) | Cas Nr | Additive Name | (mg) | Z9-16:Ald | Z11-16Ald | 16:Ald | C16:Acid |
| | | Before Test | 0 | 5.09 | 75.31 | 8.41 | 1.05 |
| 4.25 | | Blank | 0 | 3.05 | 54.31 | 6.60 | 17.72 |
| 4.25 | 3896-11-5 | Sumisorb | 4.25 | 3.20 | 56.62 | 6.81 | 15.21 |
| 4.25 | 109-99-9 | BHT | 8.5 | 3.73 | 65.80 | 7.73 | 10.43 |
| 4.25 | 1948-33-0 | TBHQ | 4.25 | 3.67 | 65.65 | 7.75 | 10.34 |
| 4.25 | 10191-41-0 | Tocopherol | 21.25 | 3.09 | 54.82 | 6.65 | 17.70 |
| 4.25 | 287476-09-9 | Dimethylethanolamine | 4.25 | 3.09 | 54.82 | 6.65 | 17.70 |
| 4.25 | 56-81-5 | Glycerol | 100 | 0.00 | 55.52 | 6.75 | 16.74 |
| 4.25 | 15922-78-8 | Sodium pyrithione | 21.25 | 4.20 | 76.47 | 8.73 | 3.34 |
| 4.25 | 52829-07-9 | Tinuvin 770 | 4.25 | 3.12 | 54.84 | 6.62 | 16.99 |
| 4.25 | 2440-22-4 | Tinuvin P | 4.25 | 3.07 | 54.01 | 6.57 | 17.66 |
| 4.25 | 110-91-8 | Morpholine | 4.25 | 3.23 | 57.13 | 6.84 | 12.54 |
| 4.25 | 1310-73-2 | Sodium Hydroxide | 0.425 | 3.18 | 55.97 | 6.65 | 12.93 |
| 4.25 | 67-68-5 | DMSO | 100 | 3.10 | 55.41 | 6.68 | 16.74 |
| 4.25 | 126-33-0 | Sulfolane | 100 | 3.08 | 54.29 | 6.60 | 16.92 |
| 4.25 | 121-79-9 | Propyl Gallate | 4.25 | 3.83 | 67.75 | 3.81 | 11.32 |
| 4.25 | 121-00-6 | BHA | 4.25 | 3.46 | 61.54 | 7.33 | 12.64 |

### Example 3

To a mixture of aldehydes containing; 4-hydroxy-TEMPO (4-hydroxy-2,2,6,6-tetramethylpiperidin-1-oxyl), (Z)-10-pentenenal, (Z)-9-hexadecenal, (Z)-11-hexadecenal, hexadecanal, (Z)-11-hexadecen-1-ol (Z)-11-hexadecenoic acid and 10 ppm Copper in the composition listed in table 3 below was added up to 1% of an additive in table below. The mixture was thoroughly mixed and heated without cap in an oven at 55 C for 14 days. As can be seen in the table, for the sample without additive the concentration of aldehydes has decreased significantly while the concentration of (Z)-11-hexadecenoic acid has increased. Surprisingly a number of compounds where particularly efficient at suppressing acid formation and degradation of the aldehydes, in particular; Zinc Pyrithione, 5-Amino-1,3,4-Thiadiazole-2-thiol, 2-thiazoline-2-thiol, 2-thiazoline-2-thiol, 5-Methyl-1,3,4-thiadiazole-2-thiol, 2-mercapto-Benzimidazole, 2-mercapto-1-methylimidazole and sodium pyrithione.

TABLE 3

| | | | | OH | Z10- | Z9- | Z11- | | Z11- | |
|---|---|---|---|---|---|---|---|---|---|---|
| g | CAS nr. | Additive | g | tempo | 15:Ald | 16:Ald | 16:Ald | 16:Ald | 16:OH | 16:Acid |
| 8.5 | 13463-41-7 | Zinc Pyrithione | 0.02 | 1.13 | 3.04 | 4.44 | 64.80 | 7.01 | 1.53 | 5.28 |
| 8.5 | 2349-67-9 | 5-Amino-1,3,4- | 0.085 | 1.20 | 2.95 | 4.92 | 72.73 | 7.81 | 2.11 | 3.03 |
| | | Thiadiazole-2-thiol | | | | | | | | |
| 8.5 | 62-56-6 | Thiourea | 0.085 | 1.06 | 3.23 | 2.98 | 48.16 | 5.31 | 1.03 | 9.46 |
| 8.5 | 96-53-7 | 2-thiazoline-2-thiol | 0.085 | 0.94 | 2.48 | 5.06 | 75.24 | 8.21 | 2.18 | 2.74 |
| 8.5 | 29490-19-5 | 5-Methyl-1,3,4- | 0.085 | 1.14 | 2.74 | 4.69 | 71.97 | 7.81 | 2.12 | 3.02 |
| | | thiadiazole-2-thiol | | | | | | | | |
| 8.5 | 583-39-1 | 2-mercapto- | 0.085 | 1.11 | 3.10 | 4.70 | 69.33 | 7.53 | 1.87 | 3.80 |
| | | Benzimidazole | | | | | | | | |
| 8.5 | 60-56-0 | 2-mercapto-1- | 0.085 | 1.11 | 2.88 | 4.83 | 72.34 | 7.82 | 1.92 | 2.93 |
| | | methylimidazole | | | | | | | | |
| 8.5 | 15922-78-8 | Sodium Pyrithione | 0.045 | 1.13 | 2.87 | 5.18 | 74.71 | 8.07 | 2.14 | 3.39 |
| 8.5 | 826-36-8 | 2,2,6,6-tetramethyl- | 0.085 | 1.21 | 3.14 | 3.83 | 59.27 | 6.41 | 1.75 | 5.70 |
| | | 4-piperidone | | | | | | | | |
| 8.5 | 2226-96-2 | 4-OH-TEMPO | 0.085 | 1.33 | 2.69 | 4.72 | 68.82 | 7.51 | 1.88 | 4.18 |
| 8.5 | | Composition before | | 1.13 | 2.61 | 5.33 | 74.98 | 8.16 | 2.16 | 3.01 |
| | | test | | | | | | | | |
| 8.5 | | Blank without | | 0.90 | 2.72 | 3.91 | 58.18 | 6.48 | 1.44 | 7.94 |
| | | additive | | | | | | | | |

### Example 4

To a mixture of aldehydes containing; 4-hydroxy-TEMPO (4-hydroxy-2,2,6,6-tetramethylpiperidin-1-oxyl), (Z)-10-pentenenal, (Z)-9-hexadecenal, (Z)-11-hexadecenal, hexadecanal, (Z)-11-hexadecen-1-ol and (Z)-11-hexadecenoic acid in the composition listed in table 4 below was added up to 1% of an additive in table below. The mixture was thoroughly mixed and heated without cap in an oven at 55° C. for 14 days. As can be seen in the table, for the sample without additive the concentration of aldehydes has decreased significantly while the concentration of (Z)-11-hexadecenoic acid has increased. Surprisingly a number of compounds where particularly efficient at suppressing acid formation and/or degradation of the aldehydes, namely; Zinc Pyrithione, 5-Amino-1,3,4-Thiadiazole-2-thiol, 2-thiazoline-2-thiol, 2-thiazoline-2-thiol, 5-Methyl-1,3,4-thiadiazole-2-thiol, 2-mercapto-1-methylimidazole and Sodium Pyrithione.

TABLE 4

| | | | | | OH | 15- | Z9- | Z11- | | Z11- | |
|---|---|---|---|---|---|---|---|---|---|---|---|
| g | | | g | Heptane | tempo | 1:Ald | 16:Ald | 16:Ald | 16:Ald | 16:OH | 16:Acid |
| 8.5 | 13463-41-7 | Zinc Pyrithione | 0.02 | 0.04 | 1.17 | 6.78 | 4.57 | 65.87 | 7.72 | 0.13 | 2.29 |
| 8.5 | 2349-67-9 | 5-Amino-1,3,4- | 0.085 | 0.04 | 1.12 | 6.82 | 4.46 | 69.41 | 7.78 | 0.12 | 1.87 |
| | | Thiadiazole-2-thiol | | | | | | | | | |
| 8.5 | 62-56-6 | Thiourea | 0.085 | 0.04 | 1.04 | 5.68 | 3.67 | 54.88 | 6.40 | 0.03 | 5.45 |
| 8.5 | 96-53-7 | 2-thiazoline-2-thiol | 0.085 | 0.04 | 0.83 | 6.26 | 4.64 | 68.79 | 8.08 | 0.00 | 1.69 |
| 8.5 | 29490-19-5 | 5-Methyl-1,3,4- | 0.085 | 0.04 | 1.14 | 6.71 | 4.38 | 71.38 | 8.04 | 0.29 | 1.38 |
| | | thiadiazole-2-thiol | | | | | | | | | |
| 8.5 | 583-39-1 | 2-mercapto- | 0.085 | 0.04 | 1.05 | 6.16 | 3.43 | 59.82 | 6.97 | 0.00 | 4.23 |
| | | Benzimidazole | | | | | | | | | |
| 8.5 | 60-56-0 | 2-mercapto-1- | 0.085 | 0.04 | 1.12 | 6.65 | 4.88 | 73.41 | 8.22 | 0.28 | 1.12 |
| | | methylimidazole | | | | | | | | | |
| 8.5 | 15922-78-8 | Sodium Pyrithione | 0.045 | 0.04 | 1.05 | 6.71 | 5.08 | 74.65 | 8.29 | 0.24 | 1.58 |
| 8.5 | 826-36-8 | 2,2,6,6-tetramethyl- | 0.085 | 0.04 | 1.11 | 6.27 | 4.03 | 61.06 | 6.95 | 0.15 | 4.02 |
| | | 4-piperidone | | | | | | | | | |
| 8.5 | 2226-96-2 | 4-OH-TEMPO | 0.085 | 0.04 | 1.53 | 6.54 | 4.52 | 67.41 | 7.60 | 0.19 | 3.00 |
| 8.5 | | Composition before | | 0.04 | 1.19 | 7.27 | 5.09 | 75.31 | 8.41 | 0.27 | 1.05 |
| | | test | | | | | | | | | |
| 8.5 | | Without additive | | 0.04 | 1.11 | 5.83 | 3.71 | 57.21 | 6.64 | 0.06 | 6.14 |

### Example 5 (Stability Tests at 5° C. And 54° C.)

Two reference samples of 14 g pheromone mixture comprising the composition listed in table 5 were sealed in 25 ml HDPE vials. Two further samples comprising 14 g of said pheromone mixture and doped with the protective agent Sodium Pyrithione (NaPyr) 0.2 wt % (Sigma Aldrich CAS No.: 3811-73-2 95% purity) were prepared in the same way.

One reference sample (sample 1) and one stabilized sample (sample 2) were placed in an oven and held at 54° C. for 14 days.

The other reference sample (sample 3) and stabilized samples (sample 4) were placed in a refrigerator at 5° C. for 17 days.

The compositions of pheromone mixture were examined by gas chromatography after the aging experiments and the results listed in Table 5.

TABLE 5

| | | Composition after aging (wt %) | | | |
|---|---|---|---|---|---|
| | Composition | 54° C. | | 5° C. | |
| | before aging | | Sample 2 | | Sample 4 |
| Protective agent 0.2% mg | (wt %) | Sample 1 | NaPyr | Sample 3 | NaPyr |
| OH-Tempo Results | 0.52 | 0.43 | 0.39 | 0.52 | 0.50 |
| 15-1:Ald Results | 0.60 | 0.63 | 0.61 | 0.60 | 0.59 |
| 15:Ald Results | 0.27 | 0.27 | 0.28 | 0.30 | 0.28 |
| 15:OH Results | 0.22 | 0.00 | 0.00 | 0.07 | 0.03 |
| Z9-16:Ald Results | 5.14 | 4.73 | 4.84 | 4.88 | 5.13 |
| Z11-16:Ald Results | 78.13 | 75.15 | 78.42 | 77.03 | 78.47 |
| 16:Ald Results | 8.25 | 7.96 | 8.28 | 8.21 | 8.32 |
| Z11-16:OH Results | 0.00 | 0.12 | 0.10 | 0.19 | 0.13 |
| 16:Acid Results | 0.31 | 0.40 | 0.27 | 0.37 | 0.12 |
| Aldol Results | 1.62 | 4.14 | 2.84 | 1.98 | 1.89 |

### CONCLUSION

The present example demonstrates that the samples (2 and 4) of pheromones comprising a protective agent, such as sodium pyrithione resulted in less aldehyde degradation than the corresponding samples without such protective agent (1 and 3). Further, the present example demonstrates that this effect is observed at both cold (5° C.) and warm environments (54° C.) rendering the protective agent effective regardless of temperature.

1. A method for protecting a fatty aldehyde and/or a fatty alcohol from degradation comprising contacting said aldehyde and/or alcohol with a protective agent comprising a sulfur containing compound, wherein the fatty aldehyde and/or fatty alcohol comprises 12 to 18 carbons and comprises one or more double bonds at position 9 ((Z)-9) and/or at position 11 ((Z)-11), and wherein the protective agent comprises a conjugated sulfur.

2. The method of claim 1, wherein the degradation occurs by one or more proccesses selected from: oxidation, aldol reaction, aldol condensation, hemiacetal, acetal formation, Cannizarro Reaction and Tishchenko Reaction.

3. The method of any one of the preceding claims, wherein the degradation occurs by oxidation.

4. The method of claim 3, wherein the degradation occurs by oxidation of the fatty aldehyde and/or fatty alcohol into an acid.

5. The method of any preceding claims, wherein the aldehyde and/or alcohol comprises 16 carbons and has a double bond at position 9 and/or at position 11.

6. The method of any preceding claims, wherein the method comprises protecting a plurality of fatty aldehydes, a plurality of fatty alcohols, and/or a combination thereof.

7. The method of claim 6, wherein the plurality of fatty aldehydes and/or alcohols comprises two or three or more different aldehydes and/or alcohols.

8. The method of any preceeding claims, wherein the fatty aldehyde and/or fatty alcohol is a pheromone.

9. The method of any preceding claims, wherein the fatty aldehyde is an arthropod pheromone.

10. The method of any preceding claim, wherein the protective agent is a corrosion inhibitor.

11. The method of any preceding claim, wherein the protective agent comprises a thiol.

12. The method of claim 11, wherein the thiol is a heterocyclic thiol.

13. The method of claim 11, wherein the thiol is an aromatic thiol.

14. The method of any preceding claim, wherein the protective agent comprises a compound selected from zinc pyrithione, 5-amino-1,3,4-thiadiazole-2-thiol, 2-thiazoline-2-thiol, 5-methyl-1,3,4-thiadiazole-2-thiol, 2-mercapto-benzimidazole, 2-mercapto-1-methylimidazole and sodium pyrithione.

15. The method of any preceding claim, wherein the aldehyde is contacted with the protective agent by mixing the aldehyde with the protective agent into a composition.

16. A composition comprising a fatty aldehyde, optionally a pheromone, and a protective agent comprising a sulfur containing compound, which protects the aldehyde from degradation, wherein the fatty aldehyde comprises 12 to 18 carbons and comprises one or more double bonds at position 9 ((Z)-9) and/or at position 11 ((Z)-11), and wherein the protective agent comprises a conjugated sulfur.

17. The composition of claim 16, wherein the degradation occurs by one or more proccesses selected from: oxidation, aldol reaction, aldol condensation, hemiacetal, acetal formation, Cannizarro Reaction and Tishchenko Reaction.

18. The composition of any one of claims 16-17, wherein the degradation occurs by oxidation.

19. The composition of claim 18, wherein the degradation occurs by oxidation of the fatty aldehyde and/or fatty alcohol into an acid.

20. The composition of any one of claims 16-19, further comprising one or more additional carriers, agents, additives and/or excipients.

21. The composition of any one of claims 16 to 20, wherein the protective agent is the protective agent of claims 11 to 14.

22. The composition of any one of claims 16 to 21, comprising at least 10 mg of the protective agent per gram aldehyde and/or alcohol.

23. The composition of any one of claims 16 to 22, comprising at least 0.5% wt of aldehyde and/or alcohol.

24. The composition of any one of claims 16-23, further comprising an oxidant or a catalyst promoting oxidation.

25. The composition of claim 24, wherein the oxidant is 4-hydroxy-TEMPO.

26. The composition of claim 24, wherein the catalyst comprises Cu.

27. The composition of claim 26, wherein the composition comprises 40 ppm Cu or less.

28. The composition of any of claims 26-27, wherein the composition comprises from 10 ppm to 40 ppm Cu, for example from 10 ppm to 30 ppm, such as from 10 ppm to 20 ppm, for example 10 ppm.

29. The composition of any one of claims 16-28, further comprising a stabilizer selected from the group consisting of: an antioxidant, a radical scavenger, a pH regulator, a buffer, a UV stabilizer, a chelator, and any combination thereof.

30. The composition of any one of claims 16-29, further comprising a stabilizer selected from the group consisting of: Sumisorb (CAS 3896-11-5); BHT (CAS 109-99-9), TBHQ (CAS 1948-33-0), Tocopherol (CAS 10191-41-0), Dimethylethanolamine (CAS 287476-09-9), Tinuvin 770 (CAS 52829-07-9), Tinuvin P (CAS 2440-22-4), Morpholine (CAS 110-91-8), Sodium Hydroxide (CAS 1310-73-2), Propyl Gallate (CAS 121-79-9), BHA (CAS 121-00-6), and any combination thereof.

31. The composition of any one of claims 16 to 26, further comprising a carrier facilitating slow release of the aldehyde and/or alcohol, optionally being (i) a polymeric substrate selected from plastic, wax emulsion, oil emulsion, or microcapsules and/or (ii) zeolite.

32. A method of controlling or monitoring a pest comprising distributing the composition of any one of claims 16 to 31 in a habitat for the pest and allowing the protected aldehyde and/or alcohol control the pest.

33. The method of claim 32, wherein the habitat is an agricultural field, and the pest is an insect such as an arthropod.
